(19) United States
(12) Patent Application Publication
(10) Pub. No.: US 2008/0289429 A1
(43) Pub. Date: Nov. 27, 2008

(54) FIBER OPTIC MEMS SEISMIC SENSOR WITH MASS SUPPORTED BY HINGED BEAMS

(76) Inventor: Tiansheng Zhou, Edmonton (CA)

Correspondence Address: DAVIS BUJOLD & Daniels, P.L.L.C., 112 PLEASANT STREET, CONCORD, NH, 03301, US

(21) Appl. No.: 11/751,777

(22) Filed: May 22, 2007

(51) Int. Cl. G01H 1/00

(52) U.S. Cl. 73/653

(57) ABSTRACT

The present invention relates to an optic seismic MEMS sensor. More specifically, a proof mass is supported by a frame having supporting beams. The proof mass is positioned within the frame and has a hinged attachment to the beams. The proof mass has a sensor gap having a first reflector and a second reflector positioned at opposing ends of the sensor gap. An optical fiber injects light into the sensor gap and light is reflected to determine seismic movement of the proof mass with respect to the frame. Stops are provided for limiting the movement of the proof mass to minimize strain on the attachment of the beams and the proof mass.

### CROSS-REFERENCE TO RELATED APPLICATION

This application claims priority from U.S. Provisional Patent Application No. 60/794,948, filed on Apr. 26, 2006, and titled FIBER OPTIC MEMS SEISMIC SENSOR WITH MASS SUPPORTED BY HINGED BEAMS, and from U.S. patent application Ser. No. 11/705,224, filed on Feb. 12, 2007 and titled FIBER OPTIC MEMS SEISMIC SENSOR WITH MASS SUPPORTED BY HINGED BEAMS.

### FIELD OF THE INVENTION

The present invention generally relates to mechanical optical devices, and, more particularly, to micro-electro-mechanical optical devices having a mass supported by hinged beams.

### BACKGROUND

The traditional method for detecting land seismic signals has been the coil-type geophone. Geophone sensors consist of a mass-spring assembly contained in a cartridge about 3 cm long and weighing about 75 grams. In a typical geophone sensor, the spring is soft and as the cartridge case moves the mass (coil) is held in place by its own inertia. Thus, the coil acts as a reference for measurement of the cartridge displacement. This sensor arrangement is ideal for measurement of large, oscillatory displacements on the order of millimeters with sub-micrometer resolution. However, the frequency range of these sensors is limited. For best sensitivity to small displacements, a given sensor has a mechanical bandwidth of about 10 Hz. Sensors can be designed with center frequencies from 20 Hz to 100 Hz.

Micro-Electro-Mechanical Systems (MEMS) are miniature mechanical components fabricated in silicon wafers. The fabrication methods are based on the same photolithographic and etching processes used to manufacture electronic circuits in silicon. In fact, most MEMS devices include not only miniature mechanical components such as nozzles, gears, etc. but also integrated electronic components to provide local signal conditioning. Unfortunately, the integrated circuits limit the maximum operating temperature of electronic MEMS to 75° C. The maximum temperature limit can be extended to 400° C. or more if optical fiber sensors are integrated with mechanical MEMS components so that no electronics are needed in the high temperature environment.

Recently, MEMS accelerometers have been developed for 3-component (3 C) land seismic measurements. In the MEMS accelerometer, a mass-spring assembly is also used, but, unlike the geophone, the spring is stiff and the mass moves with the case that houses the MEMS. The inertia of the mass causes strain and deflection of the spring and the deflection or strain that can be measured with a sensor to determine the acceleration of an object. Capacitance sensors may also be incorporated into high performance 3 C MEMS accelerometers to determine the acceleration of an object.

The measurement range of accelerometers is specified in units of ‘G’ where 1 G=9.8 m/s². Commercial specifications include 12 OdBV dynamic range (1 G to 10⁻⁶ G) and 500 Hz mechanical bandwidth with 24-bit digital resolution equivalent to a noise limited performance of 10⁻⁷ G/(Hz)^{1/2}. The accelerometer is fabricated on a silicon chip on the order of 100 mm². Three single-axis accelerometers (each with an application specific integrated circuit (ASIC) for signal conditioning) are packaged to measure in three orthogonal directions. The limitation of these accelerometers is an upper limit on the operating temperature of 75° C., which is imposed by the electronic integrated circuits and is not a fundamental limitation of silicon itself.

### SUMMARY OF INVENTION

The present invention relates to a proof mass supported by a frame having supporting beams. The proof mass is positioned within the frame and has a hinged attachment to the beams. The proof mass has a sensor gap having a first reflector and a second reflector positioned at opposing ends of the sensor gap. An optical fiber injects light into the sensor gap and light is reflected to determine seismic movement of the proof mass with respect to the frame. Stops are provided for limiting the movement of the proof mass to minimize strain on the attachment of the beams and the proof mass.

### DESCRIPTION OF THE DRAWINGS

Operation of the invention may be better understood by reference to the following detailed description taken in connection with the following illustrations, wherein:

FIG. 1 is a perspective view of a proof mass supported by hinged support beams in an embodiment of the present invention;

FIG. 2A is a side perspective view of an assembled MEMS device in an embodiment of the present invention;

FIG. 2B is a cross-sectional view taken generally along line A-A of the assembled MEMS device of FIG. 2A;

FIG. 3 is a cross-sectional view of the top portion of a sensor assembly in an embodiment of the present invention;

FIG. 4 is a detailed view of a fiber optic sensor with a proof mass in an embodiment of the present invention;

FIG. 5 is a perspective view of a variation of the fiber optic sensor;

FIG. 6 is a cross-sectional view of the variation of the fiber optic sensor;

FIG. 7 is a perspective view of the first embodiment of the triaxial assembly, where three sensors are mounted on the three mutually perpendicular surfaces at the apex of a corner of a cube in an embodiment of the present invention; and

FIG. 8 is a perspective view of an alternative embodiment of the triaxial assembly, where two sensors are shown, the third sensor would exit the page and be perpendicular to the two sensors shown; and

### DETAILED DESCRIPTION

While the present invention is described with reference to the embodiments described herein, it should be clear that the present invention should not be limited to such embodiments. Therefore, the description of the embodiments herein is illustrative of the present invention and should not limit the scope of the invention as claimed.

The present invention relates to a micro-electro mechanical system (MEMS) sensor. More specifically, the present invention relates to an interferometric MEMS optical sensor that may be used for seismic sensing. In an embodiment of the invention, the components of the optical seismic sensor are positioned to form an interferometric gap.

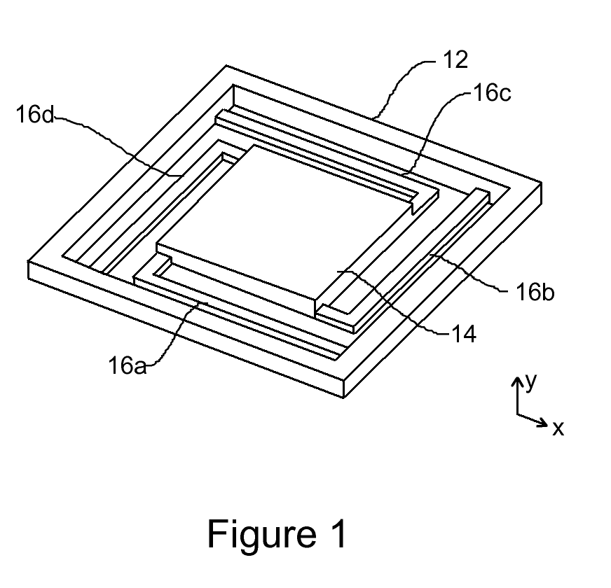

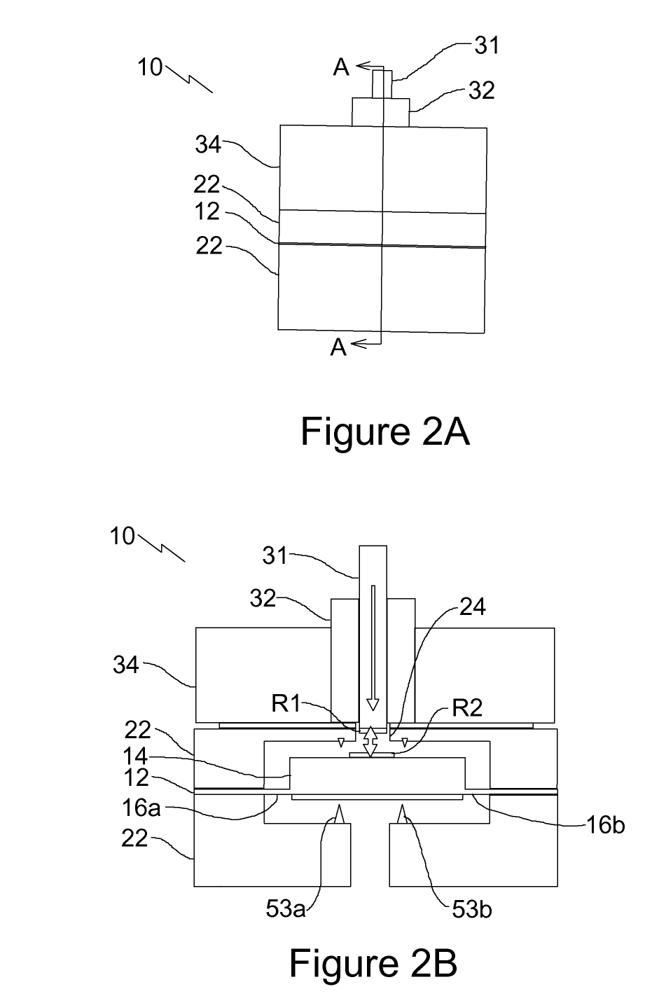

FIGS. 1 and 2B illustrate a frame 12 supporting beams 16a-16d and a proof mass 14 that may be incorporated into a sensor assembly 10. The beams 16a-16d support the proof mass 14 that may be positioned within the frame 12. In an embodiment, the proof mass 14 and the beams 16a-16d are made of silicon. One of ordinary skill in the art will appreciate that other materials may be used and that the present invention is not deemed as limited to any specific type of material. The beams 16a-16d are secured to the frame 12 to provide a stable and robust arrangement of the sensor assembly 10.

At an end of the beams 16a-16d opposite the frame 12, the beams 16a-16d are secured to the proof mass 14, as illustrated in FIG. 1. In an embodiment, the beams 16a-16d are secured to the proof mass 14 with hinges and/or secondary beams. In a preferred embodiment, the beams 16a-16d are integrally formed with proof mass 14 and frame 12, and the beams 16a-16d have as stiffness that allows them to act as “spring-loaded” hinges. To this end, the hinged attachment of the beams 16a-16d to the proof mass 14 allows the proof mass 14 to move with respect to the beams 16a-16d, but resiliently act against that movement. The beams 16a-16d are shown to be secured to the proof mass 14 at comers of the proof mass 14. In addition, the beams 16a-16d may have a uniform thickness between the frame 12 and the proof mass 14, or may be composed of parallel strips of material. In an embodiment, the proof mass 14 moves in the ±y-direction as shown in FIG. 1. The performance of sensor assembly 10 will depend upon the material and design chosen. For example, in a design where proof mass moves in the y-direction, the movement of each beam 16a-16d may be characterized by the formula K=(Eh³w)/L³, where K is the stiffness, E is Young's Modulus of the material used, L is length of the beam, h is the height if the beam and w is the width of the beam.

FIG. 2A illustrates a side view of the MEMS sensor device 10 in an embodiment of the present invention. In the embodiment of the invention illustrated in FIG. 2A and B, the frame 12 is made of silicon and positioned between glass wafers 22. In a preferred embodiment, the glass wafers 22 are borosilicate glass and are bonded to the top and the bottom surface of the frame 12. The glass wafers 22 as referred herein should not be deemed as limited to glass or borosilicate glass and may be any other materials as will be appreciated by one of ordinary skill in the art.

A cross-sectional view taken generally along line A-A of the MEMS sensor device 10 is illustrated in FIG. 2B. An optical fiber assembly 31 can be inserted into hole 24 in glass wafer 22 to direct light to the proof mass 14. In this embodiment, the beams 16a and 16b have a uniform thickness. The glass wafers 22 are illustrated on opposing sides of the frame 12.

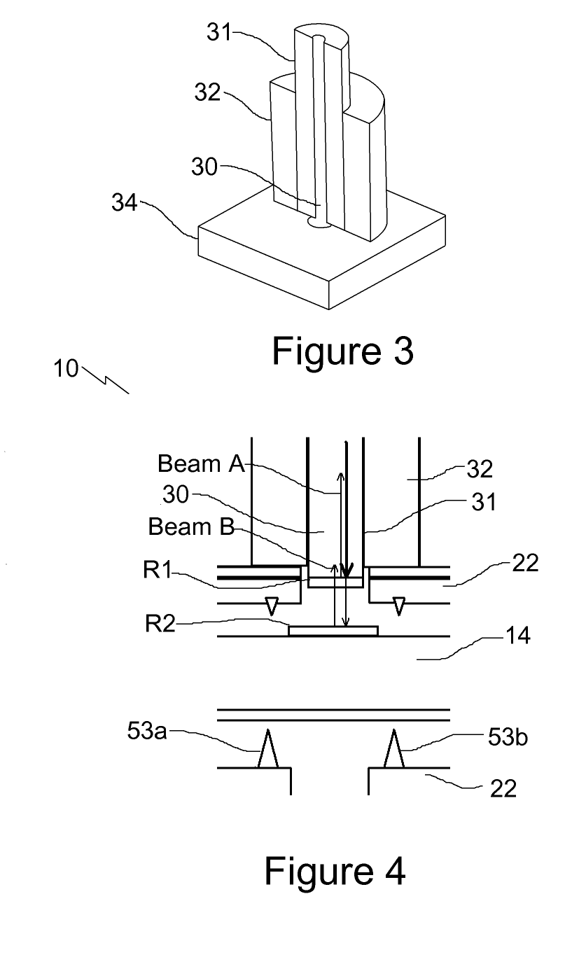

FIG. 3 illustrates a perspective view of the optical fiber assembly 31 in an embodiment of the present invention. The optical fiber assembly 31 has an optical fiber 30 held within the optical fiber assembly 31. The optical fiber 30 extends toward proof mass 14 as shown in FIG. 4 to transmit light to and/or receive reflected light from reflector R2 on proof mass 14. There are many ways of mounting optical fiber assembly 31. Referring to FIG. 3, a tube 32 houses the optical fiber assembly 31, with the optical fiber 30 contained within optical fiber assembly 31. Tube 32 is supported by a top layer 34, and as shown in FIG. 2B, may extend through top layer 34. Optical fiber assembly 31 may be soldered into place as is known in the art. Furthermore, those skilled in the art will recognize that other means may be used to mount an optical fiber to the sensor.

An optical fiber 30 injects light into the sensor assembly 10. For example, the optical fiber 30 may inject light in the C band (at approximately 1550 nm) remotely by a signal conditioner/interrogator. Light exits the end of the optical fiber 30 as illustrated in FIG. 4. In one embodiment, the end of optical fiber 30 may be angle polished and coated with an antireflection film, such as a metal or dielectric material, to reduce back reflection into the optical fiber 30. In another embodiment, where the end of the optical fiber 30 is used as the first reflector, a reflective coating may be applied instead.

Light is transmitted to the proof mass 14 and a portion of the light is reflected by reflector R1, as illustrated in FIG. 4. The portion of the light reflected from the reflector R1 is indicated as Beam A. The R1 surface, which may be a glass surface, such as a borosilicate glass surface, may be inserted after the end of the optical fiber 30. The R1 surface may also be the end of the optical fiber 30 as shown in FIG. 4. In either case, a coating may be applied onto the reflector R1 surface to increase the reflectance. The amount of reflectance of the reflector R1 may be set to a predetermined level by, for example, selecting a substance and/or a coating for the glass surface or the end of the optical fiber 30 that provides the predetermined level of reflectance.

Light not reflected at the reflector R1 travels to reflector R2 and is reflected as illustrated in FIG. 4. Reflectors R1 and R2 need to reflect light back in the same direction, such that the reflective surfaces of R1 and R2 need to be optically parallel, such that light returns through optical fiber 30 to the analyzer (not shown). The light reflected from the reflector R1 is indicated as Beam B. Beam B is reflected by the surface carried by proof mass 14. The sensor gap is defined by the separation between the reflector R1, which is either the end of optical fiber 30 or a fixed partially reflective surface, and the reflector R1, which acts as a moving reflective surface. Proof mass 14 may be designed to act as reflector R2, or reflector R2 may be integrally formed with, carried by, or otherwise movable with proof mass 14. In a preferred embodiment, the reflectance of the reflector R2 is similar to the reflectance of the reflector R1, but may be up to two or three times different. In such an embodiment, the reflector R1 is a coating that increases the reflectance. For example, in an exemplary embodiment, the reflector R2 is a gold coating. The reflector R2 is positioned and/or deposited and thus is bonded to the proof mass 14.

Other materials may be chosen for the reflectors R1 and R2 as shown in FIG. 4. In an embodiment, bare borosilicate glass (having a 3.7% reflectance) is used for the reflector R1, but other materials may be used to increase the reflectance. For example, a high index-low index dielectric stack may be used for the reflector R1 to increase the reflectance to 40% or more, if desired. In addition, materials other than the gold coating for the reflector R2 may be used. For example, aluminum, silver and/or a dielectric stack may be deposited onto proof mass 14 in order to obtain a high reflectance for the reflector R1. The present invention should not be deemed as limited to any specific material for the reflectors R1 and R2.

Movement of the proof mass 14 with respect to the frame 12 changes the sensor gap defined as the separation between reflectors R1 and R2, with the amount of movement being related to the acceleration of the sensor 10. The Beams A and B reflect back into the optical fiber 30 and may, for example, interfere on the surface of a photodiode detector in the signal conditioner (not shown). The interference signal of the Beams A and B is analyzed to precisely determine the sensor gap, and thus the acceleration of the sensor 10. The sensor 10 is, therefore, capable of sensing seismic movement.

The sensor 10 as described above and depicted in the drawings may be fabricated using wafer processing technology, such as, for example, masking, etching and bonding methods, which are well known in the art. For example, the Micragem™ process employed by Micralyne Inc. based in Edmonton, Alberta may be used to obtain satisfactory results. The Micragem process uses glass etching, anodic bonding of Pyrex glass and an SOI (Silicon On Insulator) wafer, KOH etching of the handle wafer of SOI wafer, and DRIE (Deep Reactive Ion Etching) of the device layer of the SOI wafer. In employing these steps, favorable results have been obtained by leaving a small portion of the handle wafer beneath what becomes the proof mass 14.

The supporting glass wafer 22 is bonded to the frame 12 as shown in FIG. 2b. The supporting glass wafer 22 has stops 53a, 53b that are etched into the wafer 22 to limit the movement of the proof mass 14. The supporting wafer 22 is preferably borosilicate glass and anodically bonded to the frame 12. For example, the stops 53a, 53b will limit the movement of the proof mass 14 to a predetermined distance to prevent excessive stress and possible breakage and failure of the beams 16a-16d, such as a shock of approximately 1500 g. In a preferred embodiment, the proof mass 14 is limited to a displacement of approximately five micrometers in order to maintained the stress on the beams 16a-16d at or below approximately 24×10⁶ Pa or about 0.3% of the tensile strength of silicon.

Variations

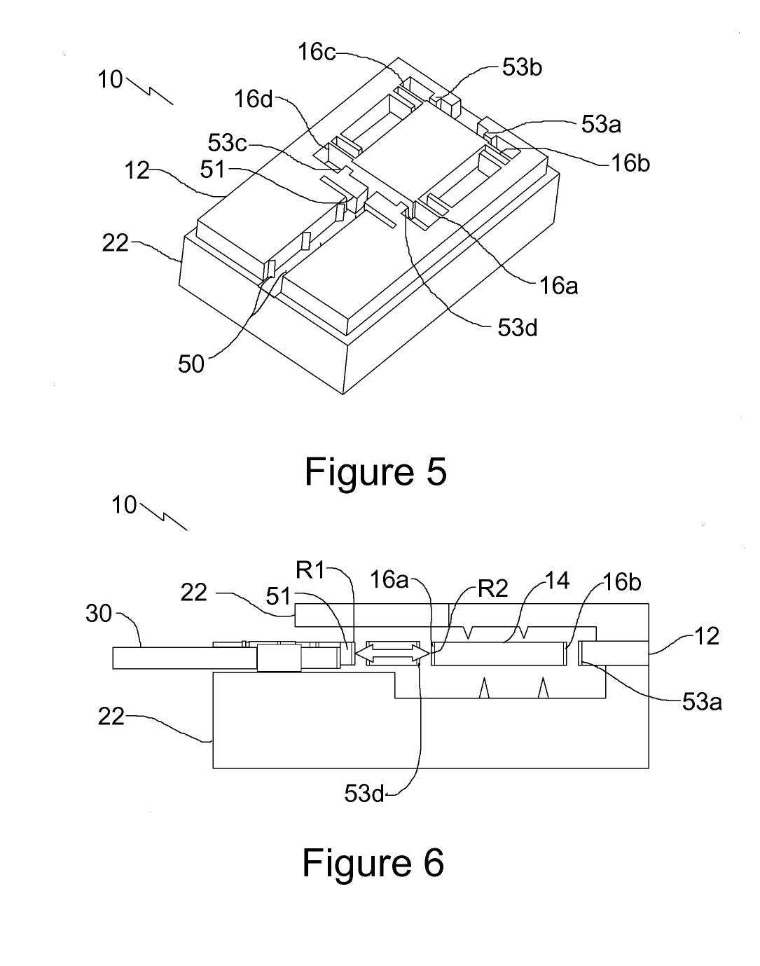

The above description is directed mainly toward a proof mass 14 positioned in a plane perpendicular to the optical fiber 30 with four support beams 16a-16d attaching it to the frame 12. However, other designs are also possible. For example, referring to FIG. 6, proof mass 14 may be positioned in a plane parallel to the optical fiber 30 rather than perpendicular. The plane of proof mass 14 that is used to define the orientation is the plane formed by beams 16a-16d as compared to the optical axis of the optical fiber 30. As shown in FIG. 5, frame 12 and proof mass 14 are integrally formed with beams 16a-16d and the portion that secures an optical fiber. Frame 12 also includes stops 53a-53d to limit the movement of proof mass 14. Frame 12 is then mounted between wafers 22. Reflector R2 is positioned on the edge of proof mass 14, and may be coated or otherwise have a reflective coating mounted accordingly, if proof mass 14 itself is insufficiently reflective. In this embodiment, reflector surface R1 is shown to be a reflective surface that is inserted into frame 12 instead using the end of optical fiber 30 as the reflector R1 as shown in FIG. 4. FIG. 5 also shows an alternative method of securing optical fiber 30, where frame 12 has inwardly protruding guides 50 to help center an optical fiber or optical fiber assembly as it is inserted, and a fiber stop 51 to indicate when the optical fiber 31 is fully inserted. In this embodiment, reflector R1 is mounted on the other side of fiber stop 51. Referring to FIG. 6, optical fiber 30 may them be soldered into place using known techniques.

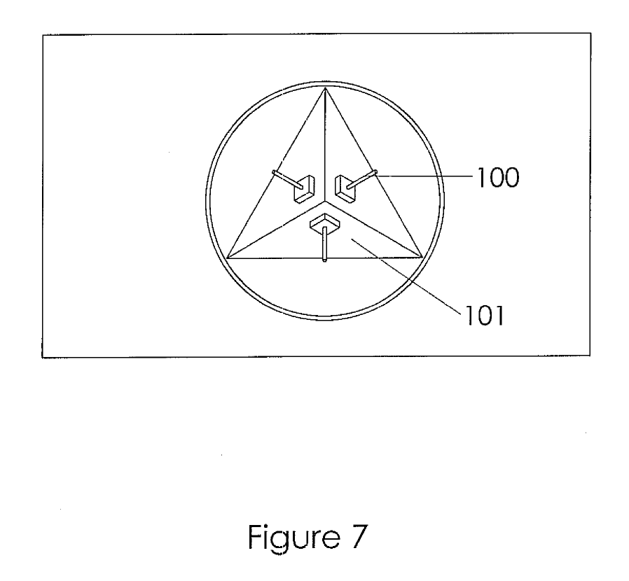

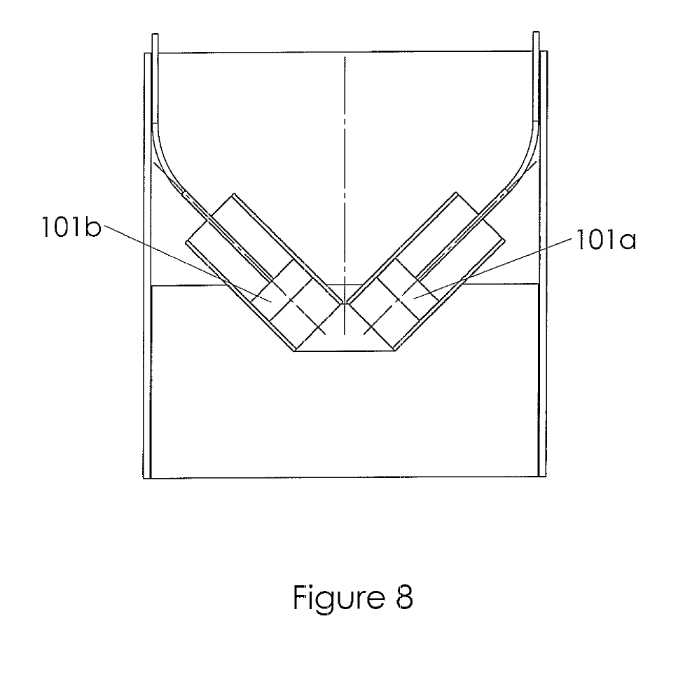

In use, the sensor 10 may be attached and/or secured in various orientations to accurately determine seismic movement. FIG. 7 illustrates a triaxial assembly of the sensors 100 attached to the corner of a cube 101. In this embodiment, the sensors 100 are positioned on three mutually perpendicular surfaces at the apex of comers of the cube 101. FIG. 8 illustrates another embodiment of the orientation of the sensors 100 where two sensors 100a, 100b are positioned at adjacent edges perpendicular to each other. The third sensor (not shown) is positioned out of the page and mutually perpendicular to the sensors 100a, 100b.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, we claim:

1. A fiber optic MEMS seismic sensor comprising:
a frame;
a proof mass supported by the frame; and
a sensor gap defined between a first reflector and a second reflector, the first reflector located adjacent the proof mass, the second reflector being movable with the proof mass and parallel to the first reflector.

2. The seismic sensor of claim 1 wherein the frame has a plurality of beams extending to support the proof mass within the frame.

3. The seismic sensor of claim 2 wherein the plurality of beams have a hinged attachment to the proof mass.

4. The seismic sensor of claim 2 further comprising:
a borosilicate glass wafer bonded to a top surface of the frame.

5. The seismic sensor of claim 1 further comprising:
a support wafer bonded to a bottom surface of the frame, the support having stopping members for limiting the movement of the proof mass.

6. The seismic sensor of claim 5 wherein the support wafer is borosilicate glass.

7. The seismic sensor of claim 1 further comprising:
an optical fiber transmitting light to the sensor gap of the proof mass.

8. The seismic sensor of claim 7 wherein the first reflector only transmits a portion of the light into the sensor.

9. The seismic sensor of claim 7 further comprising:
an angle polish on the end of the fiber to prevent back reflection.

10. The seismic sensor of claim 7, wherein the first reflector comprises the end of the optical fiber.

11. The seismic sensor of claim 1, wherein the second reflector is on a side edge of the proof mass.

12. The seismic sensor of claim 1, wherein the second reflector is in a top surface of the proof mass.

13. A fiber optic MEMS sensor, the sensor comprising:
a frame having supporting beams extending therefrom;
a proof mass having a hinged attachment to the beams, the proof mass being movable with respect to the frame; and
an optical assembly comprising an optical fiber, the optical assembly projecting a coherent beam of light through the optical fiber onto a first reflector and a second reflector, the first reflector and the second reflector having parallel reflective surfaces, the first reflector being adapted to transmit a portion of the beam of light, the first reflector being stationary relative to the frame and the second reflector being movable with the proof mass, the distance between the first reflector and the second reflector defining a sensor gap.

14. The sensor of claim 13 wherein the second reflector is one of a gold coating on at least a portion of the proof of mass, a silver coating on at least a portion of the proof mass, a top surface of the proof of mass and a side edge of the proof of mass.

15. The sensor of claim 13 wherein the first reflector is one of an end of the optical fiber and a reflective surface mounted between the end of the optical fiber and the second reflector.

16. The sensor of claim 13 further comprising:
a stopping member connected to the frame, the stopping member limiting movement of the proof mass.

17. The sensor of claim 13 further comprising:
a borosilicate glass material bonded to a top surface and a bottom surface of the frame, the borosilicate glass material on top surface reflecting a portion of the light from the optical fiber assembly back into the optical assembly.

18. The sensor of claim 17 further comprising:
a reflective coating on the borosilicate glass surface adjacent to the proof mass, wherein the reflective coating reflects substantially more of the light from the optical assembly than the borosilicate glass material.

19. The sensor of claim 18 wherein the optical assembly extends into the borosilicate glass material bonded to the top surface of the frame.
